(19) United States
(12) Patent Application Publication
(10) Pub. No.: US 2026/0259350 A1
(43) Pub. Date: Sep. 3, 2026

(54) CHAIN-TYPE METAMATERIAL ABSORBER FOR MULTI-MODE POLARIZATION-SENSITIVE INFRARED WAVELENGTHS

(71) Applicant: NORTHEAST NORMAL UNIVERSITY, CHANGCHUN (CN)

(72) Inventors: ZHONGZHU LIANG, CHANGCHUN (CN); XINYU WANG, CHANGCHUN (CN); HAIYANG XU, CHANGCHUN (CN); XIAOYAN SHI, CHANGCHUN (CN); FUMING YANG, CHANGCHUN (CN); ZHE WU, CHANGCHUN (CN); SIYU GUO, CHANGCHUN (CN); JIANGANG MA, CHANGCHUN (CN); SHENCHENG FU, CHANGCHUN (CN); YICHUN LIU, CHANGCHUN (CN)

(73) Assignee: NORTHEAST NORMAL UNIVERSITY, CHANGCHUN (CN)

(21) Appl. No.: 19/331,110

(22) Filed: Sep. 17, 2025

(30) Foreign Application Priority Data
Feb. 28, 2025 (CN) 2025102307544

(51) Int. Cl. G02B 1/00; G02B 5/00; G02B 5/08; G02B 5/22

(52) U.S. Cl. CPC G02B 1/002; G02B 5/003; G02B 5/0808; G02B 5/22

(57) ABSTRACT

The present invention discloses a multi-mode polarization-sensitive infrared band metamaterial absorber based on a chain-type structure, which comprises a metal resonator, a dielectric layer, and a metal reflection layer arranged sequentially from top to bottom. The metal resonator and the metal reflection layer form a resonant cavity for capturing incident light. The metal resonator comprises resonant units arranged periodically. Each resonant unit comprises sequentially connected resonant groups. Each resonant group comprises a central metal block, a first metal block, a second metal block, a third metal block, and a fourth metal block. The first metal block and the third metal block are disposed on one side of the central metal block and are in contact therewith. The second metal block and the fourth metal block are disposed on another side of the central metal block and are in contact therewith. The present invention achieves a multi-mode, broadband, polarized absorption response.

### TECHNICAL FIELD

The invention relates to the technical field of broadband-responsive, multi-mode, polarization-sensitive absorption, and more particularly, to a multi-mode polarization-sensitive infrared band metamaterial absorber based on a chain-type structure.

### BACKGROUND

Polarization of light has extremely broad and important applications in fields such as detection, sensing, and imaging. By providing additional spatial dimensional information, it greatly enhances the detection capabilities and accuracy in these fields. Utilizing the polarization characteristics of light allows for accurate identification of targets in complex environments and improves the detection accuracy of research targets. Metamaterial polarization absorbers can be used in infrared polarization detection and imaging technology, playing an increasingly important role in industrial inspection, biomedicine, modern military, aviation, and navigation, thus receiving growing attention.

Metamaterials are artificial composite materials with special physical properties not found in naturally occurring materials, such as negative permittivity and negative permeability. Since Landy et al. proposed a perfect single-frequency metamaterial absorber in 2008, metamaterial absorbers have begun to develop gradually. The absorption frequency of metamaterial absorbers has evolved from single-frequency to multi-frequency, and the absorption bandwidth has developed from narrowband to broadband, undergoing rapid development. With the advancement of the infrared detection field and the practical production demands for diversification and functionalization of devices, the requirements for metamaterial absorbers have also shifted from polarization-independent to polarization-dependent. However, research on polarization-sensitive absorbers is not yet complete, and there is still significant room for development. Compared to traditional polarization-insensitive metasurface absorbers, polarization-sensitive absorbers can obtain more phase and polarization information. Polarization-sensitive absorbers play a crucial role in optical imaging and detection. For example, polarization-sensitive photodetectors can be used to measure the polarization state of light, thereby improving imaging contrast and recognition probability. By acquiring the polarization characteristics of a target, the contrast between the target and the background can be significantly enhanced, solving the problem of target detection in complex backgrounds.

### SUMMARY

An object of the present invention is to provide a multi-mode polarization-sensitive infrared band metamaterial absorber based on a chain-type structure to solve the problems of difficult fabrication, complex structures, and insufficient efficiency in existing polarization-sensitive absorbers, and to achieve good polarization-selective absorption in the mid-wave infrared and long-wave infrared ranges.

To achieve the above object, the present invention provides the following technical solution:

A multi-mode polarization-sensitive infrared band metamaterial absorber, said metamaterial absorber comprising a metal resonator, a dielectric layer, and a metal reflection layer arranged sequentially from top to bottom; wherein the metal resonator and the metal reflection layer form a resonant cavity; said resonant cavity is for capturing incident light; wherein the metal resonator comprises a plurality of resonant units; each of said resonant units is periodically arranged; each of said resonant units comprises a plurality of sequentially connected resonant groups; each of said resonant groups comprises a central metal block, a first metal block, a second metal block, a third metal block, and a fourth metal block; wherein the first metal block and the third metal block are both disposed on and in contact with a first side of the central metal block; and the second metal block and the fourth metal block are disposed on and in contact with a second side of the central metal block.

Optionally, the first metal block of a resonant group is connected to the third metal block of an adjacent resonant group; the second metal block of the resonant group is connected to the fourth metal block of the adjacent resonant group; the first metal block, the second metal block, the third metal block, and the fourth metal block of each resonant group are all connected to the central metal block.

Optionally, the material of the dielectric layer is Germanium.

Optionally, the thickness of the dielectric layer is from 0.4 micrometers to 0.6 micrometers.

Optionally, the material of the metal reflection layer is a metal material or a metal compound material.

Optionally, the thickness of the metal reflection layer is 0.4 micrometers.

Optionally, the material of the metal reflection layer includes titanium, silver, aluminum, gold, iron, and nickel, and their corresponding metal compounds.

Optionally, the dimensions of the first metal block, the second metal block, the third metal block, and the fourth metal block are identical.

Optionally, each of said resonant units is periodically arranged on the upper surface of the dielectric layer.

Optionally, the thickness of the metal resonator is 0.1 micrometers.

According to the specific embodiments provided by the present invention, the invention discloses the following technical effects:

The present invention discloses a multi-mode polarization-sensitive infrared band metamaterial absorber based on a chain-type structure, wherein the metal resonator is composed of chain-type metal unit structures and possesses polarization characteristics. The metal unit structure includes two groups of metal blocks of different sizes, wherein the central metal block is surrounded by four metal blocks, periodically arranged to form a chain-type structure. The present invention achieves polarization-selective absorption of TE-polarized light and TM-polarized light in the mid-wave and long-wave infrared bands, respectively. It not only has high polarization sensitivity and can achieve a multi-mode broadband polarization absorption response in the mid-to long-wave infrared range, but also has incident angle stability, enabling the absorber to achieve efficient absorption over a wide range of incident angles from 0° to 60°, and has a simple structure that is easy to fabricate.

### BRIEF DESCRIPTION OF THE DRAWINGS

To more clearly illustrate the technical solutions in the embodiments of the present invention or in the prior art, the drawings to be used in the description of the embodiments will be briefly introduced below. It is obvious that the drawings in the following description are only some embodiments of the present invention, and for those of ordinary skill in the art, other drawings can be obtained from these drawings without creative effort.

FIG. 1 is a schematic diagram of each layer of the unit structure of the multi-mode polarization-sensitive infrared band metamaterial absorber based on a chain-type structure of the present invention;

FIG. 2 is a top-down plan view of the top metal structure of the multi-mode polarization-sensitive infrared band metamaterial absorber based on a chain-type-structure of the present invention;

FIG. 3 is a perspective view of the multi-mode polarization-sensitive infrared band metamaterial absorber based on a chain-type structure of the present invention;

FIG. 4 is the absorption spectrum of the multi-mode polarization-sensitive infrared band metamaterial absorber based on a chain-type structure of the present invention;

FIG. 5 is the absorption spectrum of the multi-mode polarization-sensitive infrared band metamaterial absorber based on a chain-type structure of the present invention at different polarization angles;

FIG. 6 is the absorption spectrum of the multi-mode polarization-sensitive infrared band metamaterial absorber based on a chain-type structure of the present invention at different incident angles.

### REFERENCE NUMERALS

1: metal resonator, 2: dielectric layer, 3: metal reflection layer, 4: central metal block, 5: first metal block, 6: second metal block, 7: third metal block, 8: fourth metal block.

### DETAILED DESCRIPTION

The technical solutions in the embodiments of the present invention will be described clearly and completely below with reference to the accompanying drawings in the embodiments of the present invention. Obviously, the described embodiments are only a part of the embodiments of the present invention, not all of them. Based on the embodiments of the present invention, all other embodiments obtained by persons of ordinary skill in the art without making creative efforts shall fall within the protection scope of the present invention.

The object of the present invention is to provide a multi-mode polarization-sensitive infrared band metamaterial absorber based on a chain-type structure, aiming to achieve a multi-mode, broadband, polarized absorption response in the mid-and long-wave infrared ranges.

The present invention achieves polarization-selective absorption of TE-polarized light and TM-polarized light in the mid-wave and long-wave infrared bands, respectively. When light with different polarizations is incident, it interacts with the horizontal and vertical unit structures, exciting polarization coupling at different wavelengths to produce absorption peaks. Through rational design, multiple absorption modes work together to achieve broadband polarization-selective absorption in the target band, which is of great significance to the development of infrared detection systems.

To make the above objects, features, and advantages of the present invention more obvious and understandable, the present invention is further described in detail below in conjunction with the accompanying drawings and specific embodiments.

### EMBODIMENT 1

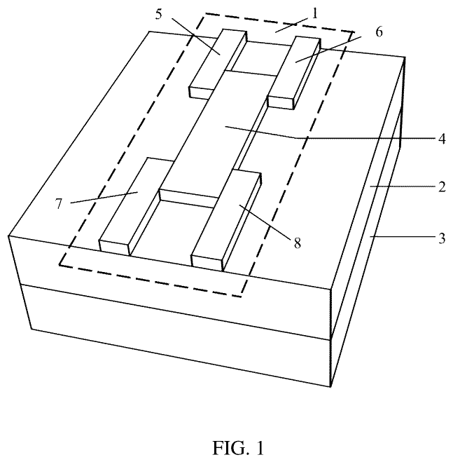

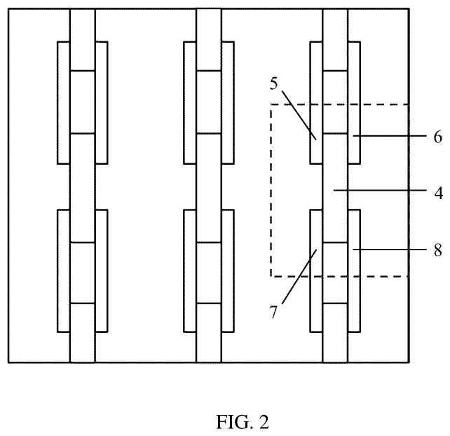

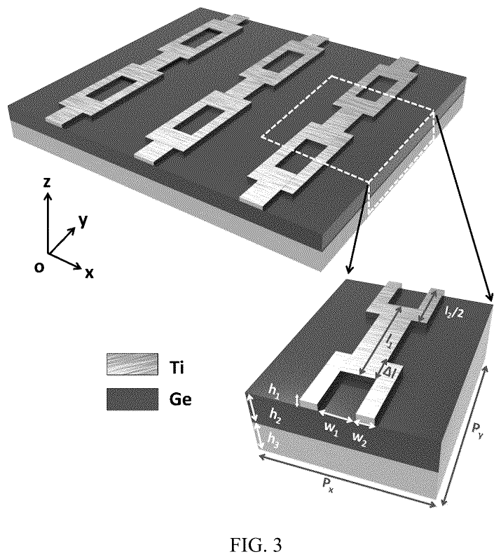

As shown in FIG. 1, FIG. 2, and FIG. 3, the multi-mode polarization-sensitive infrared band metamaterial absorber based on a chain-type structure in this embodiment includes:

A metal resonator 1, a dielectric layer 2, and a metal reflection layer 3 arranged sequentially from top to bottom.

The metal resonator 1 and the metal reflection layer 3 form a resonant cavity; said resonant cavity is for capturing incident light.

The metal resonator 1 comprises a plurality of resonant units; each of said resonant units is periodically arranged; each of said resonant units comprises a plurality of sequentially connected resonant groups; each of said resonant groups comprises a central metal block 4, a first metal block 5, a second metal block 6, a third metal block 7, and a fourth metal block 8.

The first metal block 5 and the third metal block 7 are both disposed on and in contact with a first side of the central metal block 4; the second metal block 6 and the fourth metal block 8 are disposed on and in contact with a second side of the central metal block 4.

Specifically, the central metal block 4, the first metal block 5, the second metal block 6, the third metal block 7, and the fourth metal block 8 are all cuboid structures. The bottom surfaces of the central metal block 4, the first metal block 5, the second metal block 6, the third metal block 7, and the fourth metal block 8 are all in contact with the upper surface of the dielectric layer 2. A right side of the first metal block 5 and a right side of the third metal block 7 are in contact with a left side of the central metal block 4. A left side of the second metal block 6 and a left side of the fourth metal block 8 are connected to a right side of the central metal block 4. The other two opposing sides of the central metal block 4 do not contact the first metal block 5, the second metal block 6, the third metal block 7, or the fourth metal block 8. Each of said resonant units is periodically arranged on the upper surface of the dielectric layer 2. The first metal block 5 of a resonant group is connected to the third metal block 7 of an adjacent resonant group; the second metal block 6 of the resonant group is connected to the fourth metal block 8 of the adjacent resonant group; the first metal block 5, the second metal block 6, the third metal block 7, and the fourth metal block 8 of each resonant group are all connected to the central metal block 4. The dimensions of the first metal block 5, the second metal block 6, the third metal block 7, and the fourth metal block 8 are identical.

Wherein, the upper layer is a chain-type metal resonator 1; the middle is a dielectric layer 2; the bottom is a metal reflection layer 3. The chain-type metal resonator 1 is a periodic unit structure composed of two groups of metal blocks of different sizes. The two groups of metal blocks are: a first group being the central metal block 4; a second group including the first metal block 5, the second metal block 6, the third metal block 7, and the fourth metal block 8. The periodic structure includes: one central metal block 4 and four surrounding metal blocks (first metal block 5, second metal block 6, third metal block 7, and fourth metal block 8). The four surrounding metal blocks have identical dimensions, are respectively connected to the central metal block 4, and are periodically arranged to form a grating-like structure.

Electromagnetic radiation is incident from the upper chain-type metal resonator 1. The upper chain-type metal resonator 1 and the bottom metal reflection layer 3 form a resonant cavity to capture incident light and achieve polarization-selective absorption.

The material of the upper chain-type metal resonator 1 is a metal or metal compound material, said material including: titanium, silver, aluminum, gold, iron, or nickel, or their metal compounds. The thickness h1 of the chain-type metal resonator 1 is from 0.05 μm to 0.15 μm. The overlap distance Δl is from 0.1 μm to 1.1 μm. Px and Py represent the periods of the unit structure in the x and y directions, respectively. The period in the x-direction is from 1 μm to 1.5 μm, and the period in the y-direction is 2.8 μm. Wherein, the overlap distance is the length of the side face contact between the first metal block 5, the second metal block 6, the third metal block 7, or the fourth metal block 8 and the central metal block 4. The lengths of the side face contact between the first metal block 5, the second metal block 6, the third metal block 7, or the fourth metal block 8 and the central metal block 4 are identical.

Specifically, the metal resonator 1 is formed by a periodic arrangement of metal unit structures. The thickness h1 of the metal resonator 1 is 0.1 μm. As shown in FIG. 2, the metal structure unit is a resonant group, which is formed by four identical metal blocks connected to one central metal block 4. The width w1 of the central metal block 4 is from 0.3 μm to 0.5 μm, and the length l1 of the central metal block 4 is from 1 μm to 2.8 μm. The width w2 of the four identical metal blocks (first metal block 5, second metal block 6, third metal block 7, and fourth metal block 8) is from 0.08 μm to 0.12 μm, and the length l2/2 of the four identical metal blocks is from 0.9 μm to 1.1 μm, with the value range of l2 being 1.8 μm to 2.2 μm. Through periodic arrangement, as shown in FIG. 3, a grating-like chain-type structure is formed. By adjusting the parameters, the absorption wavelength is changed to achieve absorption in the target band. Specifically, by changing the length and width of the central metal block, the length and width of the surrounding metal blocks, the thickness of the dielectric layer 2, and the periods Px and Py of the unit cell, the parameters are adjusted to achieve a redshift or blueshift of the target absorption band, thereby changing the absorption wavelength. Although a conventional grating structure can achieve polarization absorption, the absorption band is relatively narrow. This grating-like chain-type structure, through its diversified design in the x-direction, can achieve a wider absorption bandwidth while realizing polarization absorption.

The bottom is a metal reflection layer 3, which acts as a reflector and forms a resonant cavity with the upper metal resonator 1 to capture incident light. Therefore, the thickness of the bottom metal layer should be increased to be greater than the skin depth of the metal to reduce light transmission and thus enhance absorption.

The material of the bottom metal reflection layer 3 is a metal or metal compound material, said material including: titanium, silver, aluminum, gold, iron, or nickel, or their metal compounds. The thickness of the metal reflection layer 3 only needs to be greater than the skin depth of the selected material.

Preferably, the thickness h3 of the metal reflection layer 3 is 0.4 μm. The metal reflection layer 3 is a titanium metal layer.

The material of the middle dielectric layer 2 is Germanium. The dielectric layer 2 provides a sufficient real part of the refractive index for the metamaterial absorber. The thickness h2 of said dielectric layer 2 is from 0.4 μm to 0.6 μm.

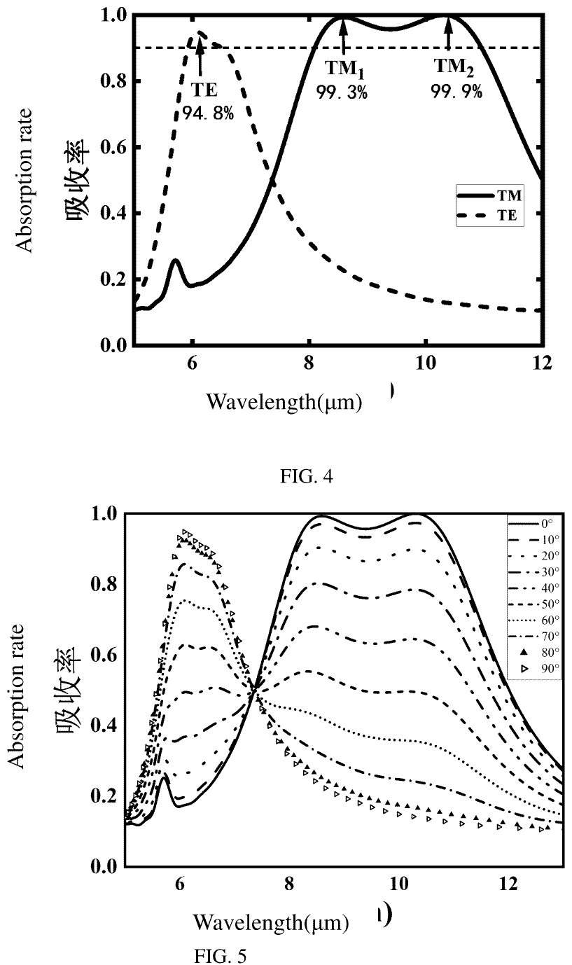

FIG. 4 shows the absorption spectrum of the polarization-sensitive absorber proposed in this embodiment under TM and TE polarized light incidence. As can be seen from FIG. 4, the resonant wavelengths of the absorber are located at 6.09 μm, 8.6 μm, and 10.32 μm, with peak absorptivities reaching 94.8%, 99.3%, and 99.9%, respectively. The average absorptivity of the absorber in the 8 μm to 11 μm wavelength range is 96.68%, allowing it to operate within a portion of the long-wave infrared atmospheric window. The absorption spectrum width for TM-polarized light is 3 μm. For TE-polarized light, the average absorptivity can reach 90.37% in the 5.85 μm to 6.8 μm mid-wave infrared wavelength range, with an absorption spectrum width of 0.95 μm.

FIG. 5 shows the polarization characteristics of the metamaterial absorber under radiation at different polarization angles. It can be seen that as the polarization angle increases, the absorption mode of the absorber gradually changes from TM dual-mode broadband absorption to TE single-mode absorption. The average absorptivity of the TM mode gradually decreases, while the average absorptivity of the TE mode gradually increases. Therefore, the absorber has excellent polarization sensitivity.

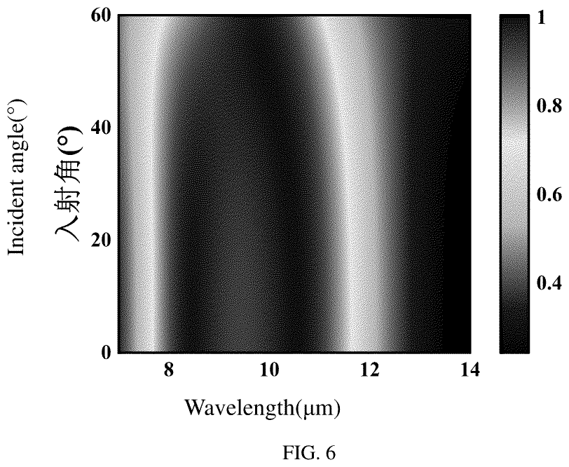

FIG. 6 shows the absorption spectrum of the polarization-sensitive absorber proposed in this embodiment at different incident angles. In practice, objects at room temperature emit infrared radiation in various random directions. Therefore, it is particularly important for a metamaterial absorber to be designed to maintain high-efficiency absorption at different incident angles. In the present invention, under oblique incidence, as the incident angle increases from 0° to 60° in steps of 10°, it is found that the average absorptivity of the absorber remains between 89.14% and 96.68% in the incident angle range of 0° to 60°. Overall, for TM polarized light incidence from 8 μm to 11 μm, the absorber can achieve an average absorptivity of 95.2% over a wide incident angle range of 0° to 60°. As the incident angle increases, the absorption peak remains almost unchanged, maintaining excellent absorption characteristics over a large angle range and demonstrating good incident angle stability.

Beneficial effects of the present invention are as follows:

The present invention achieves polarization-selective absorption of TE-polarized light and TM-polarized light in the mid-wave and long-wave infrared bands, respectively. Compared with traditional metamaterial absorbers, this absorber not only has good broadband response performance and incident angle stability, but also possesses polarization sensitivity. Furthermore, the heat distribution is concentrated, the structure is simple, and the fabrication difficulty is low. At the same time, the target band can be changed by adjusting the dimensions. It exhibits excellent absorption performance in the mid-wave and long-wave infrared, which is of great significance for infrared filtering and infrared detection.

The technical features of the above embodiments can be arbitrarily combined. To make the description concise, not all possible combinations of the various technical features in the above embodiments have been described. However, as long as there is no contradiction in the combination of these technical features, they should be considered to be within the scope recorded in this specification.

Specific examples have been used herein to explain the principles and implementation of the present invention. The description of the above embodiments is only for helping to understand the method of the present invention and its core ideas. At the same time, for a person of ordinary skill in the art, there will be changes in the specific implementation and application scope according to the ideas of the present invention. In summary, the content of this specification should not be construed as a limitation on the present invention.

1. A multi-mode polarization-sensitive infrared band metamaterial absorber based on a chain-type structure, comprising:
a metal resonator, a dielectric layer, and a metal reflection layer arranged sequentially from top to bottom;
wherein the metal resonator and the metal reflection layer form a resonant cavity configured to capture incident light;
wherein the metal resonator comprises a plurality of resonant units periodically arranged;
wherein each of said resonant units comprises a plurality of sequentially connected resonant groups, each of said resonant groups comprising a central metal block, a first metal block, a second metal block, a third metal block, and a fourth metal block; and
wherein the first metal block and the third metal block are both disposed on and in contact with a first side of the central metal block, and the second metal block and the fourth metal block are both disposed on and in contact with a second side of the central metal block, said second side being opposite to said first side.

2. The metamaterial absorber according to claim 1, wherein the first metal block of one of said resonant groups is connected to the third metal block of an adjacent resonant group, and the second metal block of said one resonant group is connected to the fourth metal block of said adjacent resonant group.

3. The metamaterial absorber according to claim 1, wherein the dielectric layer is made of Germanium (Ge).

4. The metamaterial absorber according to claim 1, wherein a thickness of the dielectric layer is between 0.4 micrometers and 0.6 micrometers.

5. The metamaterial absorber according to claim 1, wherein the metal reflection layer is made of a metal material or a metal compound material.

6. The metamaterial absorber according to claim 1, wherein a thickness of the metal reflection layer is 0.4 micrometers.

7. The metamaterial absorber according to claim 1, wherein the material of the metal reflection layer comprises one or more selected from the group consisting of titanium, silver, aluminum, gold, iron, nickel, and corresponding metal compounds thereof.

8. The metamaterial absorber according to claim 1, wherein the first metal block, the second metal block, the third metal block, and the fourth metal block have identical dimensions.

9. The metamaterial absorber according to claim 8, wherein each of said resonant units is arranged periodically on an upper surface of the dielectric layer.

10. The metamaterial absorber according to claim 1, wherein a thickness of the metal resonator is 0.1 micrometers.
